(19) United States
(12) Patent Application Publication
(10) Pub. No.: US 2017/0038018 A1
(43) Pub. Date: Feb. 9, 2017

(54) CONTROL OF BOLLARD LUMINAIRE FOR CROSSWALK

(71) Applicant: 3M INNOVATIVE PROPERTIES COMPANY, St. Paul, MN (US)

(72) Inventors: Justin M. Johnson, Hudson, WI (US); Mark G. Mathews, Oakdale, MN (US); Nicholas G. Amell, Burnsville, MN (US); Karl J.L. Geisler, St. Paul, MN (US)

(21) Appl. No.: 15/303,606

(22) PCT Filed: Apr. 14, 2015
(86) PCT No.: PCT/US2015/025749

§ 371 Date: Oct. 12, 2016

Related U.S. Application Data
(60) Provisional application No. 61/979,786, filed on Apr. 15, 2014.

(51) Int. Cl. F21S 8/08; G08G 1/005; F21V 21/14; F21V 23/04; H05B 37/02

(52) U.S. Cl. CPC F21S 8/083; F21V 23/04; H05B 37/0227; F21V 21/14; H05B 37/0281; G08G 1/005; F21W 2131/103

(57) ABSTRACT

The present disclosure describes a control scheme for actively detecting the presence of a pedestrian which triggers the lighting of a bollard-style luminaire, methods for crosswalk illumination using the bollard-style luminaires, and methods of communication between bollard-style luminaires. The present disclosure further describes actively monitoring for vehicles and indicating safe passage, through lighting feedback on a pedestrian crosswalk or other walkway. The bollard luminaire includes a design that generally confines light to illuminate the crosswalk and the pedestrian in the crosswalk, such that light that could produce glare for the pedestrian and/or a driver approaching the crosswalk is minimized.

### BACKGROUND

The potential for greatest vehicle safety advancements are in emerging economies, and in particular rural areas of developed countries. Reduced visibility at night is a key contributor to pedestrian fatalities due to vehicle/pedestrian collisions. It is desired to improve the illumination of pedestrians in crosswalks while preventing excessive glare that may endanger both drivers and pedestrians.

### SUMMARY

The present disclosure describes a control scheme for actively detecting the presence of a pedestrian which triggers the lighting of a bollard-style luminaire, methods for crosswalk illumination using the bollard-style luminaires, and methods of communication between bollard-style luminaires The present disclosure further describes actively monitoring for vehicles and indicating safe passage, through lighting feedback on a pedestrian crosswalk or other walkway. The bollard luminaire includes a design that generally confines light to illuminate the crosswalk and the pedestrian in the crosswalk, such that light that could produce glare for the pedestrian and/or a driver approaching the crosswalk is minimized. The delivery and distribution system (i.e., light duct and light duct extractor) can function effectively with any light source that is capable of delivering light which is substantially collimated about the longitudinal axis of the light duct, and which is also preferably substantially uniform over the inlet of the light duct.

In one aspect, the present disclosure provides a method for crosswalk illumination that includes detecting the presence of a vehicle; and communicating the presence of the vehicle to a network of luminaires by at least one of disabling the network, activating the network, and directing an indicator light toward the vehicle.

In another aspect, the present disclosure provides a method for crosswalk illumination that includes detecting the presence of an approaching pedestrian; and communicating the presence of the approaching pedestrian to a network of luminaires by activating the network.

In yet another aspect, the present disclosure provides a method for crosswalk illumination that includes detecting the absence of a pedestrian; and communicating the absence of the pedestrian by deactivating a network of luminaires.

In yet another aspect, the present disclosure provides a method for a bollard luminaire that includes gathering data including at least one of usage statistics of a luminaire and web scraped data; and relaying the data through a communications link.

The above summary is not intended to describe each disclosed embodiment or every implementation of the present disclosure. The figures and the detailed description below more particularly exemplify illustrative embodiments.

### BRIEF DESCRIPTION OF THE DRAWINGS

Throughout the specification reference is made to the appended drawings, where like reference numerals designate like elements, and wherein:

FIG. 1 shows a perspective schematic view of an illuminated pedestrian crosswalk;

FIG. 2 shows a control algorithm for an illuminated pedestrian crosswalk;

FIG. 3 shows a control algorithm for an illuminated pedestrian crosswalk; and

FIG. 4 shows a control algorithm for an illuminated pedestrian crosswalk.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

The present disclosure describes a control scheme for actively detecting the presence of a person which triggers the lighting of a bollard-style luminaire, methods for crosswalk illumination using the bollard-style luminaires, and methods of communication between bollard-style luminaires. The present disclosure further describes actively monitoring for vehicles and indicating safe passage, through lighting feedback on a pedestrian crosswalk or other walkway.

Bollards are often used to provide a bather between a roadway and a walk way, or divide several roadways from each other. A bollard-style luminaire as described herein can illuminate in a specific direction in order to light a walkway across a street. This is revolutionary for the bollard lighting industry, and strives to produce a safer environment for a pedestrian to cross a roadway. The present disclosure further impacts that safety factor by introducing active vehicle detection. It also adds an energy efficiency component by sensing pedestrians and disabling the light thus saving energy when no walkers are present.

The described bollard-style luminaire can be a light duct positioned vertically from the sidewalk or pavement surface that provides vertical illumination of pedestrians in a crosswalk for enhanced conspicuity and minimal glare. Suitable bollard-style luminaires useful in the present invention include those described in, for example, co-pending U.S. patent application Ser. No. 61/829,511 entitled LUMINAIRE FOR CROSSWALK (Attorney Docket No. 74227US002), filed on May 31, 2013; and BOLLARD LUMINAIRE FOR CROSSWALK (Attorney Docket No. 75199), filed on an even date herewith.

Studies evaluating various crosswalk pedestrian illumination strategies have been conducted, and initial tests of bollard-style luminaires have been shown to be promising candidates. The disclosed bollard luminaire employs a hollow light duct having appropriately designed turning (and optionally steering) films to efficiently deliver highly-collimated light within the crosswalk area, in order to maximize visual contrast between pedestrians in the crosswalk and the background environment. The fixture may be integrated with crosswalk controls either by hardwiring the controls or by wireless addressing, and/or powered by batteries that can be charged during daylight hours by solar cells or other energy harvesting technologies, for off-grid installation such as for temporary uses, or remote installations.

In the following description, reference is made to the accompanying drawings that forms a part hereof and in which are shown by way of illustration. It is to be understood that other embodiments are contemplated and may be made without departing from the scope or spirit of the present disclosure. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above those other elements.

As used herein, when an element, component or layer for example is described as forming a “coincident interface” with, or being “on” “connected to,” “coupled with” or “in contact with” another element, component or layer, it can be directly on, directly connected to, directly coupled with, in direct contact with, or intervening elements, components or layers may be on, connected, coupled or in contact with the particular element, component or layer, for example. When an element, component or layer for example is referred to as being “directly on,” “directly connected to,” “directly coupled with,” or “directly in contact with” another element, there are no intervening elements, components or layers for example.

As used herein, “have”, “having”, “include”, “including”, “comprise”, “comprising” or the like are used in their open ended sense, and generally mean “including, but not limited to.” It will be understood that the terms “consisting of” and “consisting essentially of” are subsumed in the term “comprising,” and the like.

Mirror-lined light ducts can efficiently deliver light from small light sources to be extracted and directed as desired to illuminate regions, such as pedestrian crosswalks. Such mirror-lined light ducts can be uniquely enabled by the use of optical films available from 3M Company, including mirror films such as Vikuiti™ ESR film, that have greater than 98% specular reflectivity across the visible spectrum of light. The design of a crosswalk illumination system takes into consideration the potential glare that can be hazardous to both pedestrians and drivers, and as such, the illumination area is preferably controlled such that minimal light is projected from the luminaire to either the pedestrian's eyes or the driver's eyes. Suitable control of light can be realized by using well-collimated light within the luminaire, and controlling the collimation and direction of light extracted from the luminaire.

Light emitting diode (LED) based lighting may eventually replace a substantial portion of the world's installed base of incandescent, fluorescent, metal halide, and sodium-vapor fixtures, and can be particularly well suited for use in remote illumination systems. One of the primary driving forces is the projected luminous efficacy of LEDs versus those of these other sources. Some of the challenges to utilization of LED lighting include (1) reduce the maximum luminance emitted by the luminaire far below the luminance emitted by the LEDs (e.g., to eliminate glare); (2) promote uniform contributions to the luminance emitted by the luminaire from every LED in the fixture (i.e., promote color mixing and reduce device-binning requirements); (3) preserve the small etendue of LED sources to control the angular distribution of luminance emitted by the luminaire (i.e., preserve the potential for directional control); (4) avoid rapid obsolescence of the luminaire in the face of rapid evolution of LED performance (i.e., facilitate updates of LEDs without replacement of the luminaire); (5) facilitate access to customization of luminaires by users not expert in optical design (i.e., provide a modular architecture); and (6) manage the thermal flux generated by the LEDs so as to consistently realize their entitlement performance without excessive weight, cost, or complexity (i.e., provide effective, light-weight, and low-cost thermal management).

When coupled to a collimated LED light source, the ducted luminaire system described herein can address challenges (1)-(5) in the following manners (challenge 6 concerns specific design of the LED lighting element):

(1) The light flux emitted by the LEDs is emitted from the luminaire with an angular distribution of luminance which is substantially uniform over the emitting area. The emitting area of the luminaire is typically many orders of magnitude larger than the emitting area of the devices, so that the maximum luminance is many orders of magnitude smaller.

(2) The LED devices in any collimated source can be tightly clustered within an array occupying a small area, and all paths from these to an observer involve substantial distance and multiple bounces. For any observer in any position relative to the luminaire and looking anywhere on the emitting surface of a luminaire, the rays incident upon your eye can be traced within its angular resolution backwards through the system to the LED devices. These traces will land nearly uniformly distributed over the array due to the multiple bounces within the light duct, the distance travelled, and the small size of the array. In this manner, an obeserver's eye cannot discern the emission from individual devices, but only the mean of the devices.

(3) The typical orders of magnitude increase in the emitting area of the luminaire relative to that of the LEDs implies a concomitant ability to tailor the angular distribution of luminance emitted by the luminaire, regardless of the angular distribution emitted by the LEDs. The emission from the LEDs is collimated by the source and conducted to the emitting areas through a mirror-lined duct which preserves this collimation. The emitted angular distribution of luminance is then tailored within the emitting surface by the inclusion of appropriate microstructured surfaces. Alternately, the angular distribution in the far field of the luminaire is tailored by adjusting the flux emitted through a series of perimeter segments which face different directions. Both of these means of angular control are possible only because of the creation and maintenance of collimation within the light duct.

(4) By virtue of their close physical proximity, the LED sources can be removed and replaced without disturbing or replacing the bulk of the lighting system.

(5) Each performance attribute of the system is influenced primarily by one component. For example, the local percent open area of the perforated ESR determines the spatial distribution of emission, and the shape of optional decollimation-film structures (also referred to herein as “steering film” structures) largely determines the cross-duct angular distribution. It is therefore feasible to manufacture and sell a limited series of discrete components (e.g., perforated ESR with a series of percent open areas, and a series of decollimation films for standard half angles of uniform illumination) that enable users to assemble an enormous variety of lighting systems.

One component of the light ducting portion of an illumination system is the ability to extract light from desired portions of the light duct efficiently, and without adversely degrading the light flux passing through the light duct to the rest of the ducted lighting system. Extraction of light from hollow light ducts is described further in, for example, co-pending U.S. Patent Application Ser. Nos. 61/720,118, entitled RECTANGULAR LIGHT DUCT EXTRACTION (Attorney Docket No. 70058US02); and 61/720,124, entitled CURVED LIGHT DUCT EXTRACTION (Attorney Docket No. 70224US002) both filed Oct. 30, 2012 and included herein by reference.

For those devices designed to transmit light from one location to another, such as a light duct, it is desirable that the optical surfaces absorb and transmit a minimal amount of light incident upon them while reflecting substantially all of the light. In portions of the device, it may be desirable to deliver light to a selected area using generally reflective optical surfaces and to then allow for transmission of light out of the device in a known, predetermined manner. In such devices, it may be desirable to provide a portion of the optical surface as partially reflective to allow light to exit the device in a predetermined manner, as described herein.

Where multilayer optical film is used in any optical device, it will be understood that it can be laminated to a support (which itself may be light transmissive, opaque reflective or any combination thereof) or it can be otherwise supported using any suitable frame or other support structure because in some instances the multilayer optical film itself may not be rigid enough to be self-supporting in an optical device.

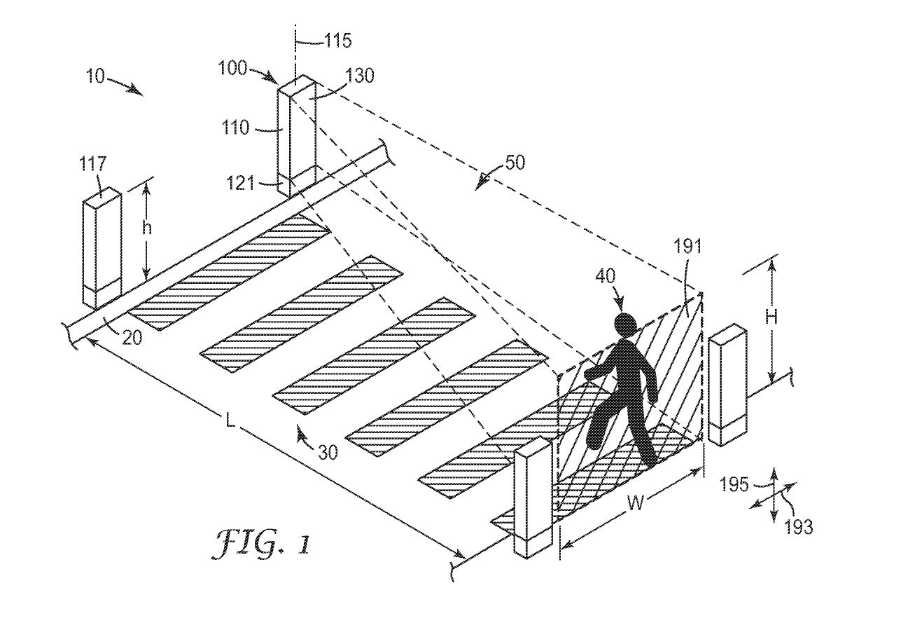

Generally, the combination of the positioning and distribution of the plurality of voids, the structured surface of the asymmetric turning film, and the structured surface of the steering film can be independently adjusted to control the direction and collimation of the light beams exiting through the light duct extractor. Control of the emission in the down-duct direction can be influenced by the distribution of the plurality of voids and the structure of the asymmetric turning film disposed adjacent the plurality of voids. Control of the emission in the cross-duct direction can also be influenced by the distribution of the plurality of voids, and the structure of the steering film disposed adjacent the asymmetric turning film. This is illustrated in FIG. 1 for a bollard luminaire and a vertical target surface. Different locations of the luminaire can illuminate different localized areas on the target surface, as described elsewhere. Tailoring the percent open area of the perforated ESR at different locations to alter the local intensity of the emitted luminance provides the means to create desired patterns of illuminance on the target surface.

FIG. 1 shows a perspective schematic view of an illuminated pedestrian crosswalk 10, according to one aspect of the disclosure. Illuminated pedestrian crosswalk 10 includes curb 20, crosswalk 30, pedestrian 40, illumination light rays 50, and at least one luminaire, such as a bollard luminaire 100 having a luminaire height “h”. In FIG. 1, four bollard luminaires 100 are shown, each disposed adjacent the crosswalk 30 on the curb 20. Each of the bollard luminaires 100 can have any desired cross-sectional shape including, for example, a rectangle such as shown in FIG. 1, a circle, an ellipse, a rectangle having at least one curved surface, or any desired polygonal or curvilinear cross-sectional shape. Suitable bollard-style luminaires useful in the present invention include those described in, for example, co-pending U.S. Patent Application Ser. No. 61/829,511 entitled LUMINAIRE FOR CROSSWALK (Attorney Docket No. 74227US002), filed on May 31, 2013; and BOLLARD LUMINAIRE FOR CROSSWALK (Attorney Docket No. 75199), filed on an even date herewith.

Bollard luminaire 100 includes a light duct 110 having a longitudinal axis 115 and a reflective inner surface surrounding a cavity. A light source 121 injects a partially collimated light beam (not shown) along the longitudinal axis 115 within the light duct 110. A portion of the partially collimated light beam can leave the light duct 110 through a light output surface 130 where light is extracted through a plurality of voids, as described elsewhere. In general, any desired number of light output surfaces can be disposed at different locations on any of the light ducts described herein.

Illumination light rays 50 leaving the light output surface 130 are directed onto an illumination region 191 adjacent crosswalk 30. The illumination region 191 can be positioned as desired along a first direction 193 perpendicular to the longitudinal axis 115 and also along a second direction 195 parallel to the longitudinal axis 115. The size and shape of the illumination region 191 can also be varied, by adjusting a distribution of voids, an asymmetric turning film, and an optional steering film (not shown) from the light duct 110, as described elsewhere. The light rays that leave the light output surface 130 can be configured to create any desired level and pattern of illumination on the illumination region 191, and generally includes an illumination height “H” and an illumination width “W” that illuminate a pedestrian in the crosswalk without producing glare in the pedestrian's eyes (or driver's eyes when approaching the crosswalk), as described elsewhere. In one particular embodiment, the bollard luminaire 100 can have the overall luminaire height “h” of about 4 feet (the top 3 feet of which is capable of emitting light), the illumination height “H” can be less than an average height of an adult pedestrian's eyes above the crosswalk, for example, about 5 feet (152 cm), and the illumination width “W” can be about the width of the crosswalk, for example, about 8 feet (244 cm).

Each of the bollard luminaires can include a transceiver for sending and receiving signals to and from neighboring units having the same wireless group ID. This board can also include connections for an optional pedestrian push button (not shown, e.g., traffic control standard 18VDC momentary push button). For example, when a button is pressed on one of the bollard luminaires in a group, that bollard broadcasts a message to all bollards with that valid group ID. Each bollard sends back acknowledgement (or ACK) signals to the broadcasting bollard as it receives the broadcast message. If one or more bollards in the group cannot be reached by the first message, the first bollard can coordinate message-routing through the bollards that are available. Once all the bollards have acknowledged the broadcast, all of the bollards may flash a few times to indicate to oncoming traffic that a pedestrian is waiting to cross. Then, all bollards may turn on (e.g., a constant, steady light) for a time period that has been predetermined as sufficient for pedestrians to cross safely. At the end of this period, the bollards may again flash a few times to indicate the light is about to turn off. An additional button press during the ON time can reset the timer, but may not necessarily trigger a new set of initial flashes. The microcontroller board can be configured to provide power to an external 18VDC momentary push button or simply detect changes in state of an externally-powered button. In one particular embodiment, messages sent between bollards via the wireless communication system are encrypted. Having separate LED/driver and control/communications boards facilitates a modular approach to product design. Control features and wireless communications capabilities can be installed for some product offerings (value-added) and not installed for others (external or no control).

In some embodiments, the lighting element can have two PCBAs: the LED and LED drivers contained on one board (Board 1), and the microcontroller and RF transceiver located on the other board (Board 2), and the two boards connected by a wiring harness or board-to-board connector. The LED board can operate independently for versions of the lighting element where no wireless control or timing sequences are required, or it can operate with a controller board for versions of the element that require these additional features. The elements can be assembled with upgraded versions of the controller board to provide useful features, including pedestrian counting, solar panel charging, cellular modems (for communication to a central server), ambient light sensing, weather reporting, asset tracking, and vehicle detection. In some cases, the board can be upgraded to include video screens or a user interface (either wireless or physical).

The electronics generally are operated using a 12 volt DC voltage—a very common power supply voltage, which can allow installers to use one of many different, inexpensive power supplies to power the lighting element (if using an on-grid supply), or to use a commonly available 12 volt battery (if used in an off-grid application).

In some embodiments, the transceiver uses a highly-directional patch antenna to direct communication out of the metal enclosure and to bollard luminaires located perpendicularly to the face of the lighting element. The resulting antenna provides for a directional, high isotropic gain, which is useful to extend a signal across wide roadways. Typical antennas provide an omnidirectional output and spread power in all directions, thus providing less signal strength in any one direction than the directional antenna. In some cases, the RF system incorporates the metallic enclosure as a ground plane to boost the transceiver's sensitivity to incoming signals.

The routing algorithms used in the communication between lighting elements can increase the communication success rate from <65% without the routing algorithm to >99% with the algorithm. This can be especially useful in a public or industrial setting, where obstacles (people, objects) prevent line-of-sight communication between lighting elements.

In one particular embodiment, other applications for the luminaire element, beyond fixed crosswalk bollard installations, include, for example: bicycle or other pathway application, orienting bollard fixtures nearly parallel to the path to illuminate the ground and ground-level objects; vehicle-mounted lights, e.g. for school buses or other vehicles where enhanced safety of incoming or outgoing passengers is desired; portable fixtures for special events and other temporary uses, for example some designs could incorporate collapsible or inflatable optical cavities; and portable task lights, where a narrow light beam is desirable (e.g. camp site).

In some cases, other variations for the luminaire element include: mix different color LEDs in the same or different horns for color/spectrum control/enhancement, RBG+ schemes—static for color configuration, dynamic for information/emergency; pedestrian and or car counter; additional indicator/blinking light(s) synchronized with main pedestrian crossing light; talking bollard audible feedback, such as “wait” or “safe to cross”, to alert pedestrians of safe walking conditions; integrated transmitting beacon to push information or notifications to nearby smartphones or other mobile devices; wireless communication with the bollard for configuration interface (in addition to or instead of current microcontroller switches); data tracking and/or gathering: e.g. syncronize via web server/cloud, sync to wireless radio in car; the exterior of the bollard could be covered with retroreflective sheeting to increase its visibility to oncoming traffic; pedestrian awareness on/off instead of manual push button (IR or ultrasonic motion detector, laser trip wire); integrated weather observatory hub with thermal, barometric, and humidity sensors for localized weather conditions; directional high-gain antenna design using the metal cavity of the bollard; wireless data extraction/programming via handheld device (phone, tablet, custom); emergency mode—including flashes (colored or not) when emergency vehicle approaches; doppler radar for traffic speed information; and attached advertisement or electronic advertisement display on the sides.

The communication between bollard luminaires includes a custom protocol to highlight assurance of signal arrival and light synchronization between bollards in a network. Each of the bollards are assigned unique ID numbers (e.g., a 32-bit ID, allowing over 9 billion possible IDs). Each of the bollards self-join networks having the same group ID (GID), and are assigned a local bollard ID (BID) for network routing. A five-stage algorithmic approach is used to increase successful message passage, including a system of message-acknowledgement to control network flow. Further, message encryption and white-noise modulation ensures security and better performance in compliance with governmental guidelines.

Each of the bollards can self-join networks that have the same GID by “pinging” other bollards with the same GID for network joining. This includes the steps of powering up, setting an ID, sending a “request to join” message, and waiting a fixed time period (e.g., 10 seconds) for an “accept” message. If the “accept” message received, a localized BID is set and an acknowledgement (ACK) is sent to indicate that the network has been joined. If no “accept” message is received, the “request to join” message can be resent. Each of the bollards remains synchronized in button presses, even if not network-joined, although routing can be limited without an assigned network, as described elsewhere.

In some cases, obstacles such as cars, pedestrians, animals and the like that are in the crosswalk zone can impede or block directional signals sent between bollards. For at least these reasons, routing and echoing techniques can be used to pass messages around obstacles. The use of the high-gain antenna provides for an increased number of signal bounces from the ground or other obstacles for better routing capability. For example, in some cases, it may be desirable to address an adjacent bollard on the same side of a roadway by echoing a signal from a bollard on the opposite side of the roadway.

A method of communicating and controlling bollard luminaires in an illuminated crosswalk can have a five step routing process, including: sending a general broadcast message to all bollards with the same group GID; each bollard that receives the message echoes it in the network; attempts are made to route message to bollards who have not responded; attempt to directly address bollards who have not responded by repeatedly messaging them; and sending one final “ping” message in the network, having the bollards resynchronize their respective timing and states, and echo the message in the network.

In some cases, the control of the bollard luminaires in an illuminated crosswalk can include features that can, for example, detect the presence of people and light the walkway when they are near so that they can have good visibility when crossing the street; detect the presence of vehicles and light the walkway when there are no vehicles detected, to indicate to pedestrians that it is safe to cross; and turn off the light when there are no people or vehicles in the area, as the light is not giving anyone any benefit when no one is present, and that energy could be saved instead.

In one particular embodiment, the system may detect the presence of walkers (i.e., pedestrians in motion). This may eliminate the need for a person to activate the luminaire (e.g., by pressing the walk button) when they approach the crosswalk. It also may gives the system a chance to turn on the lights if they are off, or assess the safety of the crosswalk before giving the walk signal to the person without the person manually initializing the system. This may aid in compliance with the system, because no input is required by the user. It can also enable feedback to the system based on a persons' movement, which is not possible if the system requires a button press or other physical activation, in order to initialize.

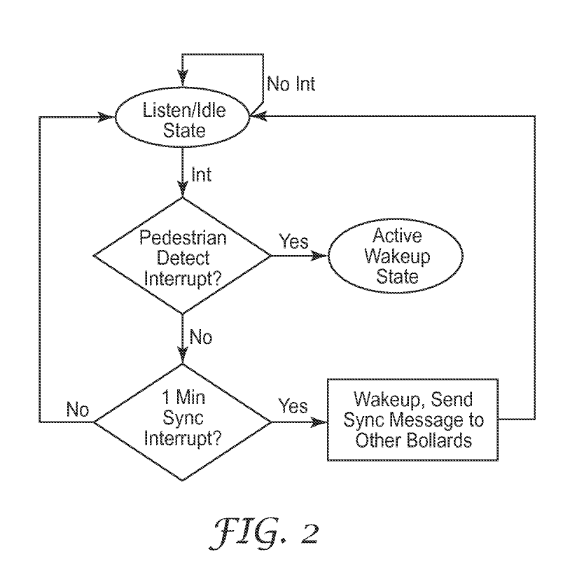

FIG. 2 shows a control algorithm for an illuminated pedestrian crosswalk, according to one aspect of the disclosure. The sensing capability algorithm depicts the pedestrian detection and idle components of the system. Each of the bollards maintains a low-power idle state between periods of lighting the crosswalk. Each minute, the master bollard in the network wakes up, reads its settings, updates the network with those settings, and sends a sync message to the other bollards in the network. If a pedestrian sensor detects pedestrian, switch to “Active/Wakeup state” for crosswalk illumination; otherwise, if no pedestrian is detected, the system again enters the low-power idle state.

Several concepts for detection of a pedestrian have been previously described, for example, using an interrupted or reflected IR beam. However, some novel concepts have been discovered by the inventors, and include, for example, some or all of the bollards can be used to detect a person based on their cell phone signal, to alert the bollards of a pedestrian at the crosswalk. Each of the bollards can be measuring the cell phone signals in their proximity, and this can be used to uniquely identify each pedestrian in the area which could enable smart on/off control of the bollards. Using signal strength measurements (e.g., RSSI) from each bollard, it is possible to know the location of a pedestrian and intelligently control the lighting so that it turns on when they approach, and stays on until they have completely walked through the intersection. This technique could be expanded to track multiple pedestrians as they all walk through and ensure that the light timings are correct in these more complex situations. In some cases, the system may also collect metrics for usage of the intersection/crosswalk for pedestrians and vehicles.

In one particular embodiment, a control system can detect the presence of vehicles and change the light output to provide feedback to the drivers or to the walkers. Several actions can result if the vehicle can be detected, and there are several ways to detect the vehicle. In some cases, a similar system that is used in vehicles for adaptive speed control, or reversing detection to determine if a vehicle is present, or by utilizing a DSRC radio signal to detect the approach of a vehicle can be utilized. Once a vehicle has been detected, several different approaches can be used to communicate with the pedestrian and/or vehicle. In some cases, the light could be disabled in the walk-way to indicate that it is not safe to cross, or instead the light could go on to indicate that there is someone in the walk way and the vehicle needs to stop. In some cases, an indicator light can be directed at the vehicles and can shine a color (e.g., red) and/or flash to indicate that there is someone in the crosswalk, while the main light may still illuminate the pedestrian.

FIG. 3 shows a control algorithm for an illuminated pedestrian crosswalk, according to one aspect of the disclosure. The sensing capability algorithm depicts the bollard activation, i.e., the process of lighting the light for the pedestrian to cross components of the system. When a pedestrian sensor (e.g., a pedestrian sensor connected to a bollard) detects a pedestrian, a set of signals is sent to the network to coordinate synchronous illumination by entering an Active Wakeup State. A Wakeup and Flash message is sent to the other bollards in the network, the vehicle sensors are read, and the sensor data is sent to the master bollard. Bollards may flash until all vehicle sensors do not detect a vehicle threat to the pedestrian, or the master bollard reaches a vehicle timeout. Once the vehicle sensors do not detect vehicles in the area, the master bollard sends out a “full turn-on” command so that each bollard synchronously stops flashing and a pedestrian can cross safely. The bollard lights remain on until pedestrians are no longer sensed in the crosswalk. The bollard detects an approaching vehicle, and then changes a state, or provides feedback to the pedestrian and the vehicle either visually or audibly, to alert both parties to the need for caution. This effect can be expanded to emergency vehicles, amber alerts or other events where extra safety and caution is necessary. These special cases are not included in the state diagram shown in FIG. 3, but can be added if desired.

In one particular embodiment, the system may include turning off the lights when no one is around. This concept may use accurate environmental sensing in order to be implemented successfully; a non-trivial action. For example, if a vehicle presence and a person presence are known, the lighting can be disabled when no one is around. This may also require a fast response lighting system, which traditional street lights do not meet as they take a long time to come on and go off. This light disabling/enabling system can result in energy savings by only lighting the crosswalk when the system network indicates the requirements are met.

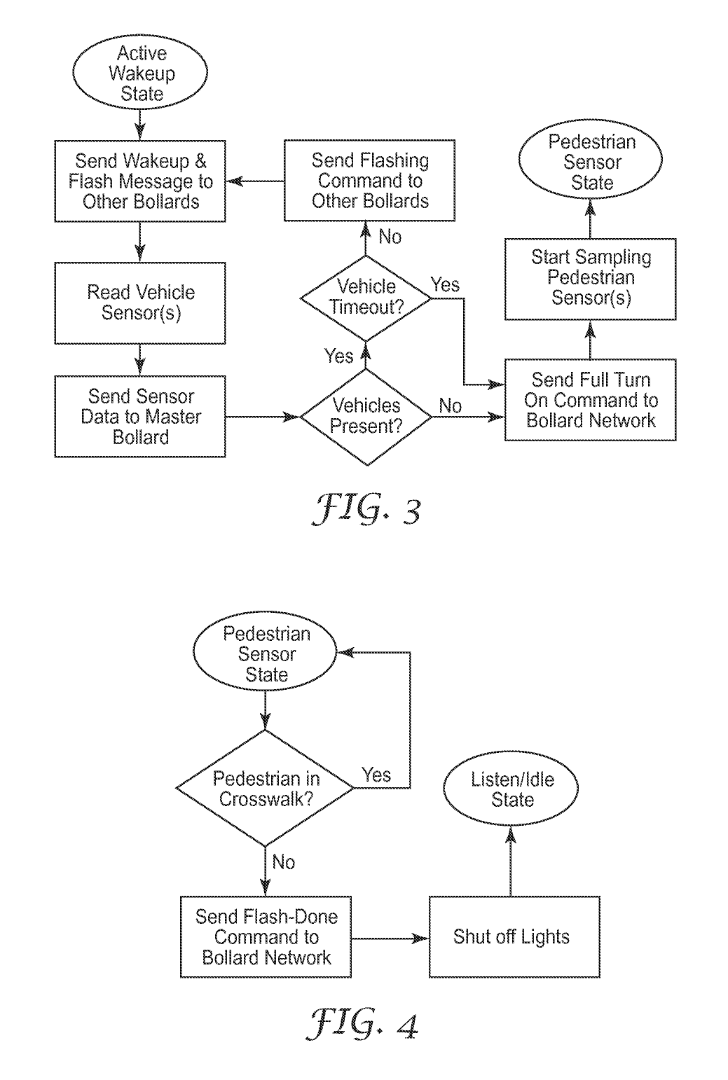

FIG. 4 shows a control algorithm for an illuminated pedestrian crosswalk, according to one aspect of the disclosure. The sensing capability algorithm depicts the return to idle/listen state diagram, thereby reducing power consumption, and reserving the lighting for situations when safety is a concern. This concept may be especially important to reduce “desensitization” of the lights for a driver. For example, if the lights are continuously on, the driver may eventually not associate the lights with a walker/alert/safety situation, and the impact can be reduced. By restricting lighting in the presence of a pedestrian, the link and importance of noticing the lights and pedestrian is maintained. In one particular embodiment, the steps may include: while the bollards are active and fully turned on and pedestrians are in the crosswalk, they sample their pedestrian sensors; once pedestrians have exited the crosswalk, the master bollard sends a “flash-done” command to the network to exit the active state; the bollards flash to alert to pedestrians and vehicles that their lights will shut off; and after a brief flashing period, the bollards shut off and return to the listen/idle state.

In some cases, the pedestrian sensors can be used to perform several actions including, for example: sensors can scan the crosswalk for pedestrians during active states and near crosswalk ends and street curbs during idle states; a pedestrian on either end of the street can trigger a wakeup message to the bollard network; a pedestrian in the crosswalk can be sensed by only one pedestrian sensor to extend the “full turn-on” time; when the crosswalk has cleared, as determined by the pedestrian sensors, the master bollard can send the flash-done message and begin its final flashing state; and the sensors nearest the street curbs can always be enabled, whereas those for the crosswalk may only enabled during the “full turn-on” state.

In some cases, the vehicle sensors can be used to perform several actions including, for example: sensors can scan the area for vehicles both external and internal to the crosswalk; for a vehicle to be detected, only one sensor in the network needs to sense it; the bollard that senses a vehicle can relay the message to the master bollard; the master bollard can set a timer for a maximum sensing time, and if the timer reaches maximum with a vehicle still detected, the vehicle can then be assumed to be stopped near the crosswalk and in range of the sensor, and the master bollard will determine it is safe for pedestrians to cross; and the vehicle sensors are disabled during the active/“full turn-on” state.

In some cases, the bollard can be provided with hardware and software to enable communication from the bollard to and/or from a server or other computer for the purpose of data gathering. For example, a bollard luminaire can include a communication link to a central server and/or cloud connectivity for relaying data. The communication link can be, for example, a cellular modem, a wi-fi, or any other IEEE 802.x standard device; and the data communicated may be usage statistics uploaded from the bollard luminaire to the central server for aggregation and analysis. In some cases, the data communicated can be web scraped data (e.g., weather, sporting events, concerts, construction information, and the like) downloaded from the cloud and/or central server to the bollard luminaire in order to improve local performance.

The contents of each of the messages in the above referenced algorithms can include several components. For example, the WAKEUP MESSAGE includes initial time delay before flashing, message routing content, and sensor check commands; the SYNC MESSAGE includes brightness—“full turn-on” time limit—sensor status, message routing content, and inventory check of available/powered bollards; the SENSOR DATA MESSAGE includes pedestrian and vehicle detection information, directionality of pedestrian or vehicle vector, and sent directly (or routed directly) to master bollard of network; the FLASH MESSAGE includes flash frequency (i.e., do not stop until told otherwise), message routing content, and sensor check commands; the “FULL TURN-ON” MESSAGE includes length of time to stay full-on initially (i.e., non-flashing, without sensor feedback), sensor check commands (e.g., pedestrian sensors), message routing content, and reply every second if pedestrian is detected in or near crosswalk; and the FLASH-DONE MESSAGE includes flash command frequency, time delay for flashing before going to idle/listen state, and message routing content.

Following are a list of embodiments of the present disclosure.

Item 1 is a method for crosswalk illumination, comprising: detecting the presence of a vehicle; and communicating the presence of the vehicle to a network of luminaires by at least one of disabling the network, activating the network, and directing an indicator light toward the vehicle.

Item 2 is the method of item 1, wherein activating the network comprises: activating a first luminaire in the network of luminaires; broadcasting an activation signal from the first luminaire; sending an echo signal from adjacent luminaires to the first luminaire; receiving an acknowledgement response from adjacent luminaires; and illuminating a light source in each of the network of luminaires.

Item 3 is the method of item 2, wherein the steps of broadcasting the activation signal and sending echo signals are repeated while awaiting the acknowledgement response from adjacent luminaires

Item 4 is the method of item 2 or item 3, wherein the steps are repeated a predetermined number of times.

Item 5 is the method of item 2 to item 4, wherein the step of illuminating the light source in each of the network of luminaires comprises receiving a time synchronization signal from the network.

Item 6 is the method of item 2 to item 5, wherein the step of activating the first luminaire comprises pushing a button, switching a switch, or activating a proximity sensor.

Item 7 is a method for crosswalk illumination, comprising: detecting the presence of an approaching pedestrian; and communicating the presence of the approaching pedestrian to a network of luminaires by activating the network.

Item 8 is the method of item 7, wherein activating the network comprises: activating a first luminaire in the network of luminaires; broadcasting an activation signal from the first luminaire; sending an echo signal from adjacent luminaires to the first luminaire; receiving an acknowledgement response from adjacent luminaires; and illuminating a light source in each of the network of luminaires.

Item 9 is the method of item 8, wherein the steps of broadcasting the activation signal and sending echo signals are repeated while awaiting the acknowledgement response from adjacent luminaires

Item 10 is the method of item 8 or item 9, wherein the steps are repeated a predetermined number of times.

Item 11 is the method of item 8 to item 10, wherein the step of illuminating the light source in each of the network of luminaires comprises receiving a time synchronization signal from the network.

Item 12 is the method of item 8 to item 11, wherein the step of activating the first luminaire comprises pushing a button, switching a switch, or activating a proximity sensor.

Item 13 is a method for crosswalk illumination, comprising: detecting the absence of a pedestrian; and communicating the absence of the pedestrian by deactivating a network of luminaires

Item 14 is a method for a bollard luminaire, comprising: gathering data including at least one of usage statistics of a luminaire and web scraped data; and relaying the data through a communications link.

Item 15 is the method of item 14, wherein the web scraped data comprises weather data, sporting event data, concert data, or construction data.

Item 16 is the method of item 14 or item 15, wherein the data is relayed either from the bollard luminaire to a central server or from the central server to the bollard luminaire

Item 17 is the method of item 16, wherein the central server comprises a cloud server.

Item 18 is the method of item 14 to item 17, wherein the communication link comprises a cellular modem, a wi-fi, or an IEEE 802.x standard device.

Unless otherwise indicated, all numbers expressing feature sizes, amounts, and physical properties used in the specification and claims are to be understood as being modified by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

What is claimed is:

1. A method for crosswalk illumination, comprising:
detecting the presence of a vehicle; and
communicating the presence of the vehicle to a network of luminaires by at least one of disabling the network, activating the network, and directing an indicator light toward the vehicle.

2. The method of claim 1, wherein activating the network comprises:
activating a first luminaire in the network of luminaires;
broadcasting an activation signal from the first luminaire;
sending an echo signal from adjacent luminaires to the first luminaire;
receiving an acknowledgement response from adjacent luminaires; and
illuminating a light source in each of the network of luminaires.

3. The method of claim 2, wherein the steps of broadcasting the activation signal and sending echo signals are repeated while awaiting the acknowledgement response from adjacent luminaires.

4. The method of claim 2, wherein the steps are repeated a predetermined number of times.

5. The method of claim 2, wherein the step of illuminating the light source in each of the network of luminaires comprises receiving a time synchronization signal from the network.

6. The method of claim 2, wherein the step of activating the first luminaire comprises pushing a button, switching a switch, or activating a proximity sensor.

7. A method for crosswalk illumination, comprising:
detecting the presence of an approaching pedestrian; and
communicating the presence of the approaching pedestrian to a network of luminaires by activating the network.

8. The method of claim 7, wherein activating the network comprises:
activating a first luminaire in the network of luminaires;
broadcasting an activation signal from the first luminaire;
sending an echo signal from adjacent luminaires to the first luminaire;
receiving an acknowledgement response from adjacent luminaires; and
illuminating a light source in each of the network of luminaires.

9. The method of claim 8, wherein the steps of broadcasting the activation signal and sending echo signals are repeated while awaiting the acknowledgement response from adjacent luminaires.

10. The method of claim 8, wherein the steps are repeated a predetermined number of times.

11. The method of claim 8, wherein the step of illuminating the light source in each of the network of luminaires comprises receiving a time synchronization signal from the network.

12. The method of claim 8, wherein the step of activating the first luminaire comprises pushing a button, switching a switch, or activating a proximity sensor.

13. A method for crosswalk illumination, comprising:
detecting the absence of a pedestrian; and
communicating the absence of the pedestrian by deactivating a network of luminaires.

14. A method for a bollard luminaire, comprising:
gathering data including at least one of usage statistics of a luminaire and web scraped data; and
relaying the data through a communications link.

15. The method of claim 14, wherein the web scraped data comprises weather data, sporting event data, concert data, or construction data.

16. The method of claim 14, wherein the data is relayed either from the bollard luminaire to a central server or from the central server to the bollard luminaire.

17. The method of claim 16, wherein the central server comprises a cloud server.

18. The method of claim 14, wherein the communication link comprises a cellular modem, a wi-fi, or an IEEE 802.x standard device.
